(19) United States
(12) Patent Application Publication
(10) Pub. No.: US 2008/0066624 A1
(43) Pub. Date: Mar. 20, 2008

(54) SOUS VIDE COOKER WITH INTEGRATED IMMERSION CIRCULATOR

(76) Inventors: Alex Taylor, Las Vegas, NV (US); Carlos Buscgelia, Las Vegas, NV (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/697,023

(22) Filed: Apr. 5, 2007

Related U.S. Application Data
(60) Provisional application No. 60/789,587, filed on Apr. 6, 2006.

(51) Int. Cl. A47J 27/62; A47J 27/00

(52) U.S. Cl. 99/330; 426/523

(57) ABSTRACT

A sous vide cooking appliance which holds the cooking liquid and vacuum packed food, circulates the liquid, heats the liquid, and regulates the temperature of the liquid.

### CROSS-REFERENCE TO RELATED APPLICATION

This application claims the benefit of U.S. Provisional Application No. 60/789,587 filed on Apr. 6, 2006.

### FIELD OF THE INVENTION

The present invention pertains to a method and appliance for cooking food, and more particularly, for sous vide cooking.

### BACKGROUND OF THE INVENTION

The sous vide (literally translated: under vacuum) cooking method was developed in France in 1974 by Georges Pralus. The method involves vacuum sealing an uncooked food product in a specially designed pouch and slowly cooking the product in the bag at a relatively low temperature (120-180 degrees Fahrenheit) by immersing it in heated water. As opposed to traditional surface contact cooking methods, sous vide cooking retains all of the food's natural moisture and juices. This results in three distinct advantages. First, flavors are retained and are unmatched by any other cooking method. Sous vide cooking produces naturally tasty and aromatic food. Second, the process requires significantly less salt and oil than other cooking methods. This results in a healthier product than cooking methods requiring food to be doused with sodium and oils. Finally, the slow cooking process allows fibers to soften and dissolve, which leaves the final product significantly more tender than conventional cooking methods.

Original sous vide methods relied on maintaining pots of water on stovetops at constant and precise temperatures. The most significant breakthrough in sous vide technology to date was the application of scientific grade immersion circulators to control the water temperature and ensure proper cooking. Scientific circulators allow chefs to set the desired temperature and virtually ignore the cooking process until they are ready to serve the food. For instance, a piece of meat can stay in the water at 140 degrees for one hour or for eight hours and it will never rise above medium rare.

Professional chefs rely on several different manufacturers of scientific grade immersion circulators and attach the circulators to pots or insulated plastic containers in order to cook sous vide. Others rely on thermal baths, which are heated tubs of water. The disadvantage of thermal baths is the water is not circulated through a thermal core and the temperature can be slightly uneven around the food. There are no known products on the market that combine both a thermal circulator and thermal bath into one unit. Furthermore, even though the process of sous vide has been known and developed for over thirty years, sous vide cooking has yet to enter the home cooking arena. Many professional chefs advise against home sous vide cooking, as it is too time consuming, labor intensive, and frustrating to attempt to monitor the temperature of a pot of water on the stove for long periods of time. If the water being used in the sous vide process rises above the desired temperature, the food will be overcooked and the damage cannot be undone. These problems would be remedied by a product that holds, heats, regulates, and circulates water for the sous vide cooking process.

The object of the present invention is to provide a method and appliance for sous vide cooking in an integrated unit that holds, heats, regulates, and circulates the cooking liquid. Another object is to solve the principal hurdles involved in widespread acceptance of the sous vide method. The invention is superior to scientific grade immersion circulators because it is a fully integrated unit, as opposed to a unit that must be attached to an additional vessel that is often designed in conjunction with the circulator. It is superior to thermal baths in that it will more accurately regulate the temperature of the water and provide superior precision sous vide cooking. Yet another object of the invention is to provide a method and appliance that are sufficiently easy to use to allow non-professionals to employ the sous vide cooking method at home.

### SUMMARY OF THE INVENTION

One aspect of the present invention is an appliance comprising a vessel for holding a liquid bath, one or more heater units, an immersion circulator, one or more temperature sensors, and a user input device. In another aspect of the invention the vessel further comprises a bottom wall and one or more side walls. The one or more heater units are located within the bottom wall and/or one or more of the side walls of the vessel. In another aspect of the invention the immersion circulator is integrated with the appliance and heats and circulates the liquid of the liquid bath. In another aspect of the invention the one or more temperature sensors measure the temperature of the liquid within the liquid bath and provide feedback to the one or more heater units and the immersion circulator in order to control the temperature of the liquid within the liquid bath.

In another aspect of the invention, the user input device allows the user to set the desired temperature for the liquid in the liquid bath. In another aspect of the invention, the user input device allows the user to set a timer. In another aspect of the invention the appliance further comprises a display providing information regarding the temperature and timing.

Another aspect of the present invention is a method of sous vide cooking comprising the steps of placing liquid into a vessel having a bottom wall and one or more side walls, inputting desired cooking settings, heating the liquid using one or more heater units located in the bottom wall and/or one or more of the side walls of the vessel and using an immersion circulator, circulating the liquid using the immersion circulator, sensing the temperature of the liquid using a temperature sensor, providing feedback from the temperature sensor to the one or more heater units and the immersion circulator, and placing vacuum packed food items by user into the liquid for cooking.

In another aspect of the invention, inputting cooking settings includes inputting temperature. In another aspect of the invention, inputting cooking settings includes inputting length of time. In another aspect of the invention, information regarding temperature and timing is displayed.

In another aspect of the invention, the side and bottom walls are insulated to reduce heat loss. In another aspect of the invention, the vessel further comprises a cover. In another aspect of the invention, the cover is transparent to allow observation of the contents of the vessel. In another aspect of the invention, the cover is insulated to reduce heat loss.

In another aspect of the invention, the vessel further has a battery to maintain settings and heating in the event of power failure. In another aspect of the invention, an alarm sounds to notify user when temperature deviates from set temperature.

In various aspects of the invention, the side and bottom walls of the appliance are insulated. In various aspects of the invention, the appliance further comprises a cover. In one aspect of the invention, the cover is transparent to allow observation of the contents of said vessel. In another aspect of the invention, the cover is insulated to reduce heat loss. In various aspects of the invention, the appliance further comprises a battery to maintain settings and heating ability in the event of a power failure. In various aspects of the invention, the appliance further comprises an alarm to notify the user in case of temperature deviation from set temperature.

### BRIEF DESCRIPTION OF THE DRAWINGS

FIG. 1 illustrates a top view of one embodiment of the sous vide appliance.

FIG. 2 is a side view of the embodiment of the sous vide appliance through the line A-A of FIG. 1.

### DETAILED DESCRIPTION OF THE PREFERRED EMBODIMENT

The method and appliance of the present invention allow for sous vide cooking, suitable for in-home or professional use. In the context of the present invention, users may include individuals or groups of individuals desiring to prepare food using the sous vide cooking method. These users could be professional cooks, such as at a restaurant, café, or cafeteria or could be home users in their personal kitchens.

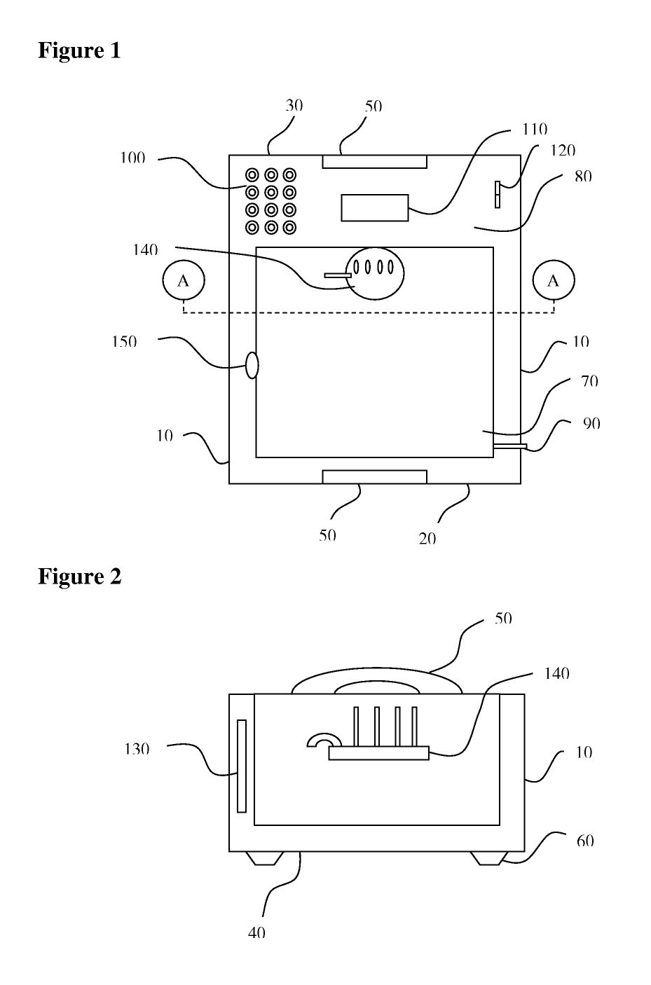

One embodiment of the appliance is shown in FIG. 1 and FIG. 2. The appliance includes two side walls 10, a front wall 20, a rear wall 30, and a bottom wall 40. On top of the front and rear walls handles are mounted 50, to allow the appliance to be moved easily and without spilling the contents if full. On the bottom wall rubber footings are attached 60 to provide stability to the appliance and prevent it from inadvertently slipping or moving. On the inside, the appliance is divided into two chambers, a heating chamber 70 and an electronic control chamber 80. The heating chamber is sufficiently large to hold several sous vide pouches and sufficient cooking liquid to efficiently heat the pouches. The heating chamber is open on the top, allowing the introduction of the liquid comprising the liquid bath and vacuum packed food items for cooking. The heating chamber is further equipped with a drain 90 for removing the liquid comprising the liquid bath. The electronic control chamber is completely enclosed. On the top of the electronic control chamber are mounted a user input device 100, an LED display 110, and a power switch 120.

In one embodiment of the present invention, the liquid comprising the liquid bath is placed in the heating chamber. In the context of the present invention, the heating liquid can be water or another liquid which can flow through the circulator and retain heat. The desired settings are entered through the user input device 100, located on top of the electronic control chamber. These settings could include, but are not limited to, the desired cooking temperature and the length of cooking time. In the preferred embodiment, the LED display 110 on top of the electronic control chamber reflects these input settings, as well as information such as time remaining in the cooking cycle.

In this embodiment, the liquid bath is heated in response to the entered settings. Heating is accomplished through the use of one or more heating units 130 located in one or more side walls of the appliance and/or in the bottom wall of the appliance. Heating is further accomplished through the use of an integrated immersion circulator 140, which heats the liquid as it passes through the circulator. The immersion circulator also circulates the water, maintaining an even temperature throughout the liquid bath.

Located in one or more side walls and/or in the bottom wall are one or more temperature sensors 150. These sensors monitor the temperature of the liquid bath and provide feedback to the heating units and the immersion circulator. This feedback allows the heating units and immersion circulator to maintain the temperature at the desired setting, for instance by shutting off if the temperature is above the desired level or by increasing heat output if temperature is below the desired level.

In another embodiment of the present invention, the side and/or bottom walls of the appliance are insulated to reduce heat loss. In another embodiment, the appliance also has a cover which can be closed over the heating chamber, preventing loss of the cooking liquid through evaporation. In one embodiment the cover is transparent, allowing observation of the contents of the appliance. In another embodiment, the cover is insulated, preventing heat loss.

In another embodiment of the present invention, the appliance has a battery, located in the electronic control chamber. This battery provides backup power, maintaining the settings and heating ability of the appliance in the event of a power failure. In another embodiment, the appliance has an alarm to notify the user, for instance, when the temperature deviates from the set temperature or when the user set time has lapsed.

The descriptions of the present embodiments are not intended to limit the present invention but merely to provide an illustration of possible embodiments applying the principles of the invention. Numerous other uses could be made by those skilled in the art without departing from the spirit and scope of the invention.

We claim:

1. An appliance comprising:
a vessel for holding a liquid bath;
one or more heater units;
an immersion circulator;
one or more temperature sensors; and
a user input device,
wherein said vessel further comprises a bottom wall and one or more side walls;
wherein said one or more heater units are located within said bottom wall and/or one or more of said side walls of said vessel;
wherein said immersion circulator is integrated with said appliance and said immersion circulator heats and circulates liquid within said liquid bath; and
wherein said one or more temperature sensors measure the temperature of said liquid within said liquid bath and provide feedback to said one or more heater units and said immersion circulator in order to control the temperature of said liquid within said liquid bath.

2. The appliance of embodiment 1, wherein said user input device allows the user to set a desired temperature for said liquid in said liquid bath.

3. The appliance of embodiment 1, wherein said user input device allows the user to set a timer.

4. The appliance of embodiments 2 and 3, further comprising a display providing information regarding said temperature and said timing.

5. The appliance of embodiment 1, wherein said side and bottom walls are insulated.

6. The appliance of embodiment 1, further comprising a cover.

7. The appliance of embodiment 6, wherein said cover is transparent to allow observation of the contents of said vessel.

8. The appliance of embodiment 6, wherein said cover is insulated to reduce heat loss.

9. The appliance of embodiment 1, further comprising a battery to maintain settings and heating ability in the event of a power failure.

10. The appliance of embodiment 1, further comprising an alarm to notify the user in case of temperature deviation from set temperature.

11. A method of sous vide cooking comprising the steps of:
placing liquid into a vessel having a bottom wall and one or more side walls;
inputting desired cooking settings;
heating said liquid using one or more heater units located in said bottom wall and/or one or more of said side walls of vessel and using an immersion circulator;
circulating said liquid using said immersion circulator;
sensing the temperature of said liquid using a temperature sensor;
providing feedback to said one or more heater units and said immersion circulator from said temperature sensor; and
placing vacuum packed food items by user into said liquid for cooking.

12. The method of embodiment 11, wherein inputting cooking settings includes inputting temperature.

13. The method of embodiment 11, wherein inputting cooking settings includes inputting length of time.

14. The method of embodiments 12 and 13, further comprising the step of displaying information regarding said temperature and said timing.

15. The method of embodiment 11, wherein said side and bottom walls are insulated.

16. The method of embodiment 11, wherein said vessel further comprises a cover.

17. The method of embodiment 16, wherein said cover is transparent to allow observation of the contents of the vessel.

18. The method of embodiment 16, wherein said cover is insulated to reduce heat loss.

19. The method of embodiment 11, wherein said vessel further has a battery to maintain settings and heating in the event of power failure.

20. The method of embodiment 11, further comprising the step of an alarm sounding to notify user when temperature of liquid bath deviates from set temperature.
